(19) United States
(12) Patent Application Publication
(10) Pub. No.: US 2007/0121621 A1
(43) Pub. Date: May 31, 2007

(54) Integrated active-active fibre channel capability in SATA and SAS devices

(76) Inventors: Michael Moretti, Palo Alto, CA (US); Kelvin Kao, San Jose, CA (US)

Correspondence Address: RAJ ABHYANKER, LLP;c/o PORTFOLIOIP, P.O. BOX 52050, MINNEAPOLIS, MN, 55402, US

(21) Appl. No.: 11/369,489

(22) Filed: Mar. 7, 2006

Related U.S. Application Data
(63) Continuation-in-part of application No. 11/291,116, filed on Nov. 30, 2005.

(51) Int. Cl. H04L 12/56; H04J 3/16

(52) U.S. Cl. 370/389; 370/466

(57) ABSTRACT

Integrated active-active fibre channel capability in SAS and SATA is disclosed. In one embodiment, a system includes a data processing system to communicate a fibre channel frame through a network and a conversion module in a storage device coupled to the network to translate between the fibre channel frame and one or more of a SATA frame and a SAS frame. The conversion module may further include an active-active module to provide multiple paths from the data processing system to the storage device, a context associated with one or more outstanding commands, and a mapping module to translate between a logical block address and a logical block address count for one or more of a 520 block, a 524 block, and a 528 block SCSI command and a corresponding logical block address and a corresponding logical block address count for a 512 block SATA command.

### CLAIM OF PRIORITY

This application claims priority from the non-provisional application Ser. No. 11/291,116 titled “Active-active fibre channel capability in SATA and SAS devices” filed on Nov. 30^{th}, 2005.

### FIELD OF TECHNOLOGY

This disclosure relates generally to the technical fields of storage environments, in one example embodiment, to an integrated active-active fibre channel capability in SAS and SATA system and apparatus.

### BACKGROUND

Fibre channel is a high performance serial link supporting its own, as well as higher-level protocols such as the Fiber Distributed Data Interface (FDDI), Small Computer System Interface (SCSI), High-Performance Parallel Interface (HIPPI), and Internet Policy Institute (IPI) protocols. Fibre channel is often used as a transport mechanism in storage area networks (SANs) in which personal computers and servers are connected to storage devices and other peripherals through a fibre channel transport. By moving storage to a SAN, administrators have the bandwidth to share and/or allocate storage to a much larger audience on a network. The fibre channel transport mechanism can often be used because it allows for fast transfer of large amounts of information to and from nodes of a SAN.

Serial Advanced Technology Attachment (serial ATA) devices (e.g., SATA hard drives) are frequently used as storage devices in personal computers. Consequently, serial ATA devices are manufactured in very high volumes. Fibre channel devices (e.g., specialized fibre channel hard drives based on the SCSI standard) are manufactured in low volumes, because they are primarily used in SAN environments. As a result, serial ATA devices tend to be less costly than fibre channel devices because of reasons including economies of scale achieved through higher volume production of serial ATA devices. For example, component costs for serial ATA devices can cost 3-5 times less than the cost of components for fibre channel devices. In addition, serial ATA devices have a thin serial cable that facilitates more efficient airflow inside a form factor and also allows for smaller chassis designs.

Serial Attached SCSI (SAS) is a serial communication protocol for storage devices. SAS uses serial communication instead of the parallel method found in many SCSI devices but still uses SCSI commands for interacting with SAS devices. SAS supports up to 16,384 addressable devices in a SAS domain and point to point data transfer speeds up to 3 Gbit/s (e.g., in the future may be higher than 10 Gbit/s). The SAS connector is much smaller than traditional parallel SCSI connectors allowing for small 2.5 inch drives.

Serial ATA and SAS devices cannot work in environments where fibre channel is used as a transport mechanism, because the fibre channel standard does not support serial ATA and SAS protocols.

### SUMMARY

Integrated active-active fibre channel capability in SAS and SATA is disclosed. In one aspect, a system includes a data processing system to communicate a fibre channel frame through a network and a conversion module (e.g., which may process the fibre channel frame and other fibre channel frames on a frame by frame basis) in a storage device coupled to the network to translate between the fibre channel frame and one or more of a SATA frame and a SAS frame. The system may also include a controller module coupled to the conversion module to process the SATA frame and the SAS frame.

The system may further include an active-active module of the conversion module to provide multiple paths from the data processing system to the storage device (e.g., to enable processing of 128 concurrent commands from at least 32 data processing systems through a processor having separate payload buffers for data throughput from queue structures for processing header information).

The system may also include a context (e.g., of a fixed size which may be allocated prior to receiving the fibre channel frame and the other fibre channel frames) of the conversion module associated with one or more outstanding commands (e.g., information including a MTU size, a SAS hash address, a fibre channel source identifier, an expected state, a pointer allocation for putting on queue, and a command descriptor block (CDB)). The system may maintain an expected frame state (e.g., which may be created prior to forwarding one or more of an expected fibre channel frame, an expected SATA frame, and an expected SAS frame) to anticipate and expedite the one or more of the expected fibre channel frame, the expected SATA frame, and the expected SAS frame processed by the conversion module. The system may also include an expected frame validation performing a protocol validation through one or more header validation operations.

Furthermore, the system may include a mapping module in the conversion module to translate between a logical block address and a logical block address count for one or more of a 520 block, a 524 block, and a 528 block hard disk SCSI command and a corresponding logical block address and a corresponding logical block address count for a 512 block SATA disk (e.g., while the mapping module flows through the translation as any one of a next fibre channel frame, a next SATA frame, and a next SAS frame is processed by the conversion module).

In another aspect, an apparatus includes a conversion module in a storage device (e.g., a SATA and/or a SAS device) to convert an incoming command of an initiator (e.g., a data processing system) to a format of a communication protocol associated with the storage device, and a controller module of the storage device coupled to the conversion module to generate an output data responsive to the incoming command. The initiator may use data provided in the incoming command to update an expected state of a next frame of the initiator.

The apparatus may validate an incoming frame using any one of a SAS, a SATA, and a fibre channel protocol and it may also validate the initiator of the incoming frame using a SCSI protocol. The apparatus may further be used to process a header data of the incoming command in one or more queue structures and a payload data of the incoming command in one or more payload buffers.

In yet another aspect, a method includes a data processing system communicating to one or more of SAS devices and one or more of SATA devices through a first fibre channel network and a second fibre channel network, processing data between the one or more of SAS devices and the data processing system through the first fibre channel network and the second fibre channel network using a first translation module in each of the one or more of SAS devices, and processing data between the one or more of SATA devices and the data processing system through the first fibre channel network and the second fibre channel network using a second translation module in each of the one or more of SATA devices. The method may further provide multiple paths between the data processing system and the one or more of SATA devices having the second translation module with at least two ports.

The methods may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the Figures of the accompanying drawings, in which like references indicate similar elements and in which:

FIG. 1 is a block diagram of a module having multiple fibre channel ports and a SATA port, according to one embodiment.

FIG. 2 is a block diagram of a module having multiple fibre channel ports and multiple SAS ports, according to one embodiment.

FIG. 3 is a network diagram of the modules of FIG. 1 and FIG. 2 operating in a fibre channel environment, according to one embodiment.

FIG. 4 is a block diagram of data segmentation, queuing, and buffering in the module, according to one embodiment.

FIG. 5 is a perspective view of a storage device which contains a conversion module within the storage device, according to one embodiment.

FIG. 6 is a diagrammatic representation of a data processing system capable of processing a set of instructions to perform any one or more of the methodologies herein, according to one embodiment.

FIG. 7 is a process flow of communication between the data processing system of FIG. 3 and one or more SATA/SAS devices through two fibre channel networks, according to one embodiment.

Other features of the present embodiments will be apparent from the accompanying drawings and from the detailed description that follows.

### DETAILED DESCRIPTION

Integrated active-active fibre channel capability in SAS and SATA system and method is disclosed. In the following description, for purposes of explanation, numerous specific details are set forth in order to provide a thorough understanding of the various embodiments. It will be evident, however, to one skilled in the art that the various embodiments may be practiced without these specific details. An example embodiment provides methods and systems for a storage device that includes a conversion module in a storage device to translate between a fibre channel frame and a SATA frame and/or a SAS frame, and a data processing system to communicate through a fibre channel network with the storage device through two or more ports on the conversion module. Example embodiments of a method and a system, as described below, may be used to provide active-active fibre channel capability for SATA and SAS devices. It will be appreciated that the various embodiments discussed herein may/may not be the same embodiment, and may be grouped into various other embodiments not explicitly disclosed herein.

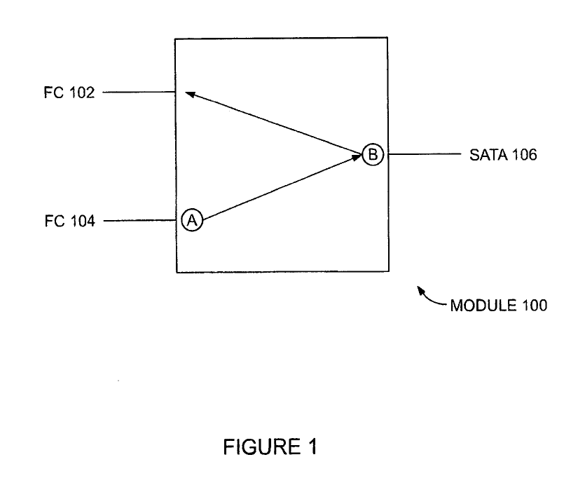

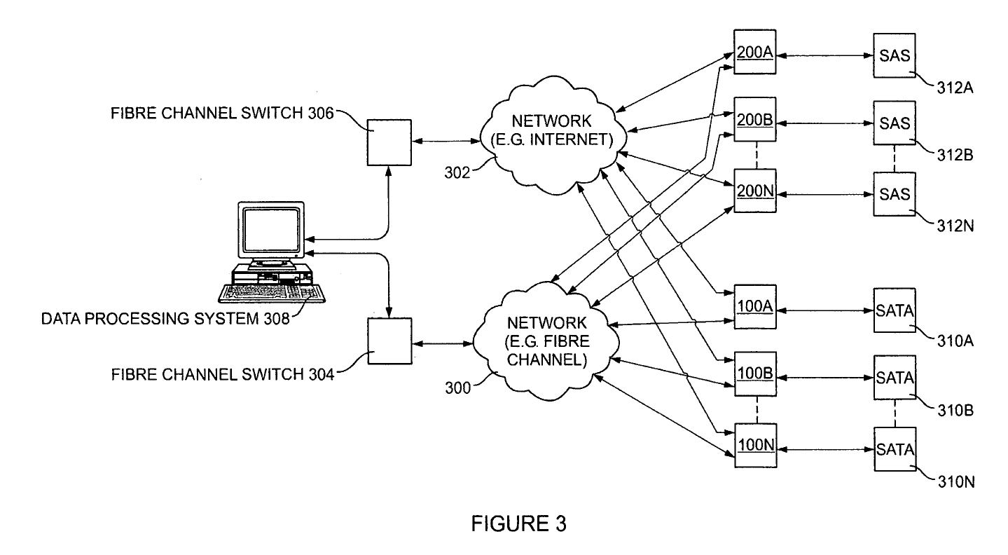

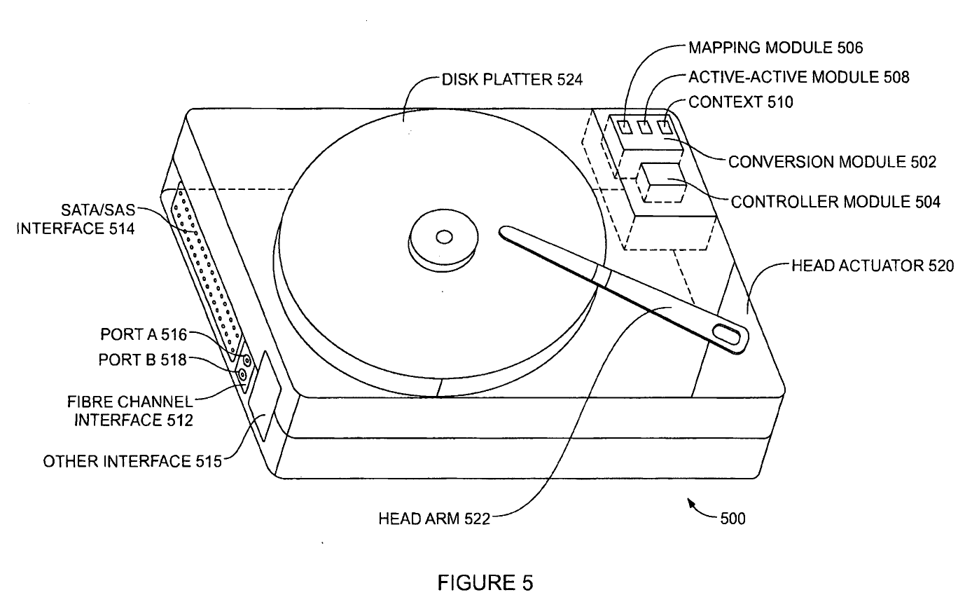

FIG. 1 is a block diagram of a module 100 having multiple fibre channel ports (a fibre channel port 102 and a second fibre channel port 104) and a SATA port 106, according to one embodiment. The fibre channel port 102 and the fibre channel port 104 may connected to different fibre channel switches. For example, the fibre channel port 102 may be connected to a fibre channel switch 304 in FIG. 3, whereas the fibre channel port 104 may be connected to a fibre channel switch 306 in FIG. 3. The SATA port 106 may be connected to a SATA storage device, such as a SATA hard drive (e.g., such as a SATA hard drive 310A). In an alternate embodiment, the SATA port 106 may be connected to circuitry in a conversion module 502 internal to a storage device as illustrated in FIG. 5, and another circuitry in a controller module 504.

Illustrated in FIG. 1 is a circle ‘A’ near the fibre channel port 104. The circle ‘A’ represents a communication path of frames of data from the fibre channel port 104 to the SATA port 106. First, a validation occurs of an initiator of a particular frame. For example, the initiator may be a data processing system 308 as illustrated in FIG. 3, and the module 100 may validate that a particular source identifier is associated with the data processing system 308 when a frame is received from the fibre channel port 104.

It should be noted that data flows through the module 100 and only the command is translated in one embodiment. Also, a frame size validation can be made. For example, a mapping module 506 of FIG. 5 (e.g., in a conversion module 504 of FIG. 5) of the module 100 may flow through a translation of the data (e.g., the conversion module 504 may translate a LBA and a LBA count in a SCSI command from the data processing system 308 that assumes the command is for a 520 block, a 524 block, and/or a 528 block hard disk to a proper LBA and a LBA count for a 512 block SATA disk).

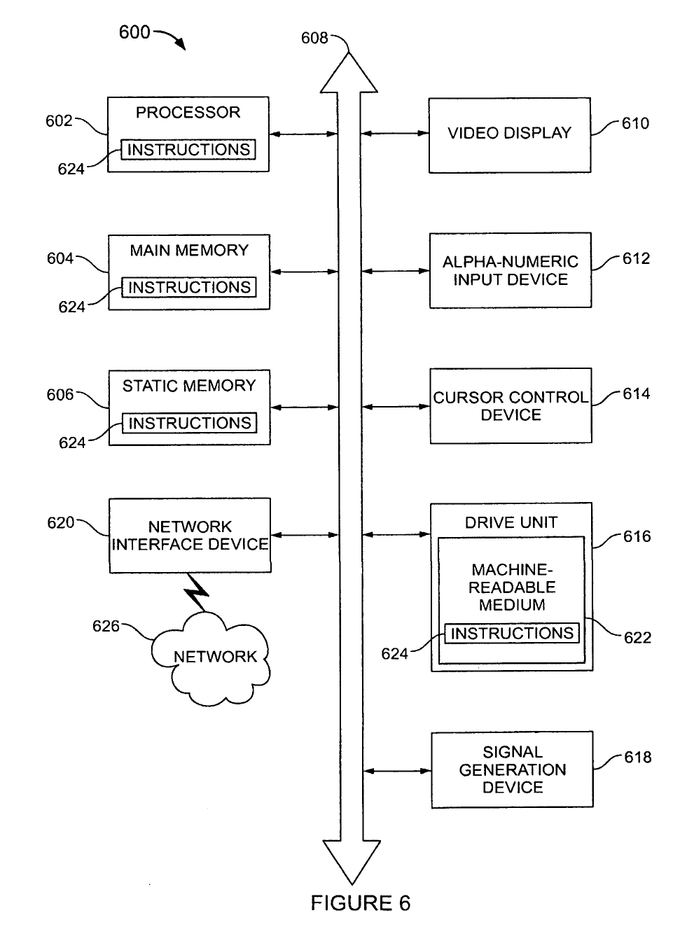

After the validation is made, an interpretation is made whether the incoming fibre channel frame includes a payload having a command that can be processed by a SATA protocol (e.g., read, write, etc.). If not, the module 100 may process incompatible commands (e.g., a verify command) internally (e.g., using a processor such as the processor 602 of FIG. 6), and return a response to an initiator (e.g., the data processing system 308 of FIG. 3).

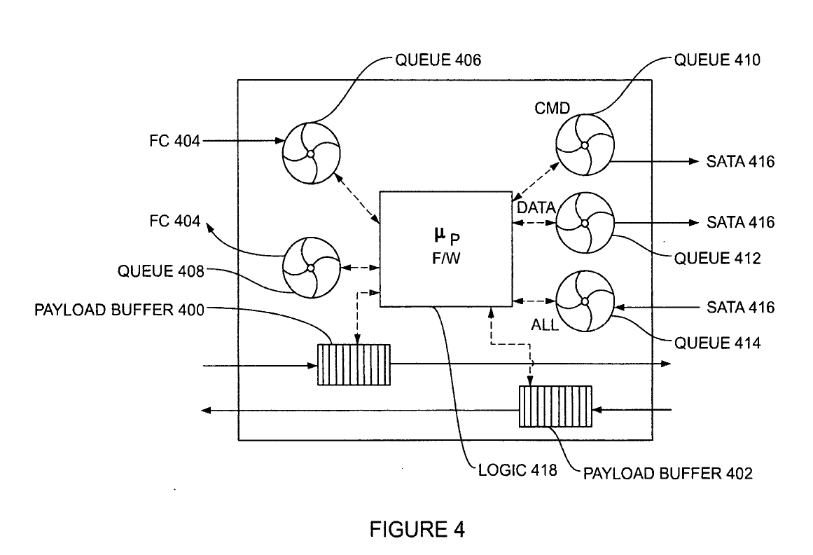

If the data is a compatible command, the module 100 may convert the command from a fibre channel protocol to a serial ATA protocol (e.g., using a logic 418 as illustrated in FIG. 4). In one embodiment, data received from the fibre channel port 102 and/or the fibre channel port 104 may provide multiple paths for load balancing or throughput purposes and a combined throughput from the multiple paths set may be provided to a SATA hard drive (e.g., the SATA hard drive 310A of FIG. 3) connected to the SATA port 106.

As a result, the SATA hard drive (e.g., the SATA hard drive 310A of FIG. 3) may work similarly in an active-active mode, or a mode that enables the SATA hard drive to provide multiple paths from the data processing system (e.g., the data processing system 308) to the storage device (e.g., while two ports are illustrated in FIG. 1, alternate embodiments of the module 100 of FIG. 1 may have any number of fibre channel ports). The data processing system 308 may not know that it is associated with a SATA hard drive while believing that it is associated with a dual ported fibre channel drive, according to one embodiment. In another alternate embodiment, if a network associated with the fibre channel port 102 fails (e.g., a network 300 of FIG. 3), then data may be transmitted over an alternate network over the fibre channel port 104 (e.g., such as over a network 302 as illustrated in FIG. 3).

In addition, illustrated in FIG. 1 is a circle ‘B’ near the SATA port 106. In the operation of circle ‘B’, the module 100 may check if a particular frame received is an expected frame by examining stored information from a previous frame having data about a next expected frame (e.g., a previous frame sent from a SATA device through the module 100A of FIG. 3 to the data processing system 308 of FIG. 3). Also, the module 100 may determine a particular command context (e.g., a set of attributes that give a meaning/value/parameter to a particular type of command). A validation may then be made of the frame (e.g., by checking if identification information of the header is what was expected). Then, the frame may be converted into a fibre channel frame from a SATA frame and sent out over either the fibre channel port 102 and/or the fibre channel port 104 (e.g., by using the logic 418 of FIG. 4).

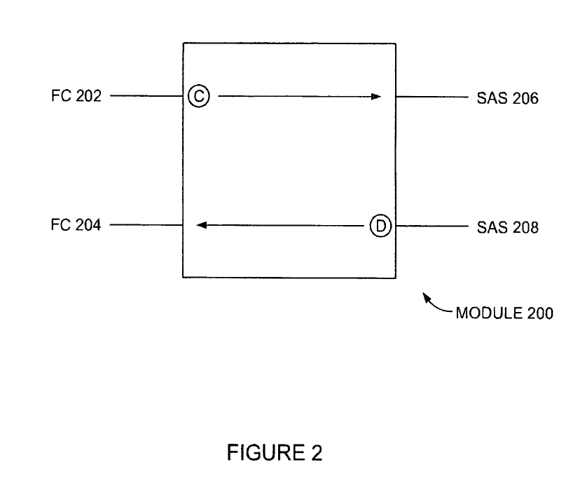

FIG. 2 is a block diagram of a module 200 having multiple fibre channel ports (e.g., a fibre channel port (FC) 202 and a fibre channel port (FC) 204) and multiple SAS ports (e.g., a SAS port 206 and a SAS port 208), according to one embodiment. The module 200 may be similar to module 100, but used to convert between fibre channel frames and SAS frames (e.g., in both directions), rather than between fibre channel frames and SATA frames (e.g., in both directions).

Illustrated in FIG. 2 is a circle ‘C’ near the fibre channel port 202. The operations of circle ‘C’ may involve the translation (e.g., conversion, processing, etc.) from fibre channel frames to SAS frames. First, an initiator (e.g., the data processing system 308) may be validated. Then the frame header (e.g., a frame header of an incoming fibre channel frame) may be validated (e.g., using an algorithm that examines a header having a source identifier). Next, an expected next header state may be updated (e.g., so the module 200 knows what type of frame to expect next). Then, the fibre channel frame may be converted to a SAS frame, and sent through the module 200.

In addition, illustrated in FIG. 2 is a circle ‘D’ near the SAS port 208. The operations of circle ‘D’ may involve translation (e.g., conversion, processing, etc.) from SAS frames to fibre frames. First, a frame header may be validated (e.g., similarly to the process discussed in circle ‘C’). Then an expected next state may be updated. A conversion may then be made to an outgoing fibre channel frame (e.g., by reformatting data into an appropriate frame size, and modifying header information). Finally, the data may be transmitted through the fibre channel port 204.

FIG. 3 is a network diagram of the modules of FIG. 1 and FIG. 2 operating in a fibre channel environment, according to one embodiment. Illustrated in FIG. 3 are a network 300, and a network 302. The data processing system 308 is coupled to the network 300 (e.g., fibre channel) through the fibre channel switch 304, and data processing system 308 is coupled to the network 302 (e.g. internet) through the fibre channel switch 306. In case the network 300 associated with the fibre channel switch 304 is disabled, then data may be transmitted over an alternate network 302 over the fibre channel switch 306.

SATA drives 310A, 310B, to 310N and SAS drives 312A, 312B, to 312N are coupled to the network 300 and the network 302 through devices 100A, 100B, to 100N (e.g., which are different versions of the module 100 of FIG. 1) and devices 200A, 200B, to 200N (e.g., which are multiple versions of the module 200 of FIG. 2), respectively. The devices 100A, 100B, to 100N process data between the SATA drives 310A, 310B, to 310N and the network 300, and the devices 200A, 200B, to 200N process data between the SAS drives 312A, 312B, to 312N and the network 302.

Data may be sent from the data processing system 308 through the fibre channel switch 306 and the network 302 into the module 100A in one port, and also from the data processing system 308 to the fibre channel switch 304 to the network 300 to the other port on the module 100A. Thus the module 100A may receive two inputs, one from the network 302, and one from the network 300. The SATA drives 310A, 310B, to 310N have single ports, but throughput of multiple fibre channel frames processed across different ports may enable multiple paths through the devices 100A, 100B, to 100N (e.g., fibre channel frames processed across 2 ports as shown in FIG. 1), thereby enabling the SATA drives to work in an active-active mode.

FIG. 4 is a block diagram of data segmentation, queuing, and buffering in a conversion module (e.g., the module 100 and/or the module 200), according to one embodiment. Shown in FIG. 4 are queues 406, 408, 410, 412 and 414, which are coupled with a logic 418, where commands are converted from a fibre channel (FC) protocol to a SATA protocol. Fibre channel commands are received into the queue 406. These commands may be received from an initiator (e.g., the data processing system 308 of FIG. 3).

Output headers are transmitted out from the queue 408 to the fibre channel (FC) 404. SATA signals are sent from a SATA 416 to the queue 414, where header information (e.g., which may be used to control link applications, control device protocol transfers, and detect missing or out of order frames) is stored and processed. The converted commands or the compatible commands are sent from the logic 418 to the queues 410 and 412, from where they are transmitted to the SATA 416. A payload (e.g., information to be transferred from a source port to a destination port) from the fibre channel side is sent directly to a payload buffer 400, and a payload from the SATA 416 side is sent into a payload buffer 402 for data throughput.

FIG. 5 is a perspective view of a storage device 500 which contains a conversion module 502 within the storage device 500, according to one embodiment. As illustrated in FIG. 5, the storage device 500 includes the conversion module 502, a controller module 504, a fibre channel interface 512, a SATA/SAS interface 514, an other interface 515, a head actuator 520, a head arm 522, and a disk platter 524. The conversion module 502 further includes a mapping module 506, an active-active module 508, and a context 510.

The conversion module 502 (e.g., the conversion module 502 and the data processing system 308 of FIG. 3 may be used to communicate fibre channel frames through a network) may translate between a fibre channel frame and a SATA frame and/or a SAS frame. The fiber channel frame may contain information to be transmitted (e.g., payload), an address (e.g., an IP address) of the source and/or the destination port, and/or link control information (e.g., information that controls a line, channel and/or circuit over which data are transmitted).

In one or more embodiments, the conversion module 502 may process the fibre channel frame and other fibre channel frames on a frame by frame basis (e.g., a frame with high priority may be processed before a frame with low priority). In addition, a next frame state may be maintained to anticipate and/or expedite (e.g., to execute quickly and efficiently) an expected fibre channel frame, an expected SATA frame, and/or an expected SAS frame processed by the conversion module 502 (e.g., the expected frame state may be created prior to forwarding the expected fibre channel frame, the expected SATA frame, and/or the expected SAS frame). The next frame state may be validated prior to forwarding the next fibre channel frame, the next SATA frame, and/or the next SAS frame (e.g., by performing a protocol validation through one or more header validation operations).

An active-active module 508 (e.g., in the conversion module 502) may provide multiple paths from the data processing system 308 of FIG. 3 to the storage device 500 (e.g., as described in FIG. 3). In addition, the active and active module 508 may process 128 concurrent commands from at least 32 data processing systems (e.g., the data processing system 308 of FIG. 3) through a processor having separate payload buffers from queue structures (e.g., to process header information at high data throughput).

A mapping module 506 (e.g., in the conversion module 502) may translate a 520 block, a 524 block and/or a 528 block size of a SCSI data in the fibre channel frame to a 512 block SATA frame. The mapping module 506 may flow through (e.g., to gauge the block size of the SCSI data) the translation while a next fibre channel frame, a next SATA frame, and/or a next SAS frame is processed by the conversion module 502.

A context 510 (e.g., 132 frames of data) may be associated with one or more outstanding commands. The context 510 may include information a MTU size, a SAS hash address, a fibre channel source identifier, an expected state, a pointer allocation for putting on queue, and/or a command descriptor block (CDB). The context 510 may be of a fixed size (e.g., a uniform number of bits and/or bytes). The context 510 may be allocated prior to receiving the fibre channel frame and other fibre channel frames.

The controller module 504 (e.g., in a circuit and/or a software module) may allow the data processing system 308 (e.g., illustrated in FIG. 3) to communicate with the storage device 500. Here, the controller module 504 may generate an output data that is responsive to data (e.g., the SATA frame and the SAS frame) from the conversion module 502. In addition the controller module 504 may process data fed directly through the SATA/SAS interface 514 (e.g., from a device that uses the SATA/SAS standard) to regulate a head actuator 520 (e.g., and/or other peripheral devices). The head actuator 520 may operate a head arm 522 to read and/or write information on a disk platter 524. The controller module 504 may also communicate back to the data processing system 308 of FIG. 3 through the conversion module 502.

There are three interfaces on the storage device 500. The SATA/SAS interface 514 may be used when the storage device 500 interfaces with a device using SATA and/or SAS commands. In this setting, the commands may bypass the conversion module 502 and may be fed into the controller module 504 directly. The fiber channel interface 512 may be used when the storage device 500 interfaces with a device using fibre channel frames. The fibre channel interface 512 may have two ports as illustrated in FIG. 5 (e.g., a port A 516 and a port B 518 may be similar to the fibre channel port 202 and the fibre channel port 204 of FIG. 2, respectively).

The port A 516 connects the conversion module 502 to a network A, while the port B 518 connects the conversion module 502 to a network B. It should be noted that what is illustrated here is just an example embodiment of the fibre channel interface 512. The fibre channel interface 512 may be implemented using multiple ports in addition to the two ports illustrated in this example while taking any number of physical forms encompassing any embodiment herein. The other interface 515 (e.g., an interface to a power source, a peripheral device, etc.) may be used to implement a connection to any devices.

In another example embodiment, an apparatus may include the conversion module 502 in the storage device 500 (e.g., a SAS device, a SATA device, etc.) to translate an incoming command of an initiator (e.g., the data processing system 308) to a format of a communication protocol associated with the storage device 500 (e.g., more specifically the controller module 504 in the storage device 500 coupled to the conversion module 502). The controller module 504 may generate an output data (e.g., which allows the CPU of a hosting data communication system to communicate with a hard disk, floppy disk and/or other kind of disk drive) responsive to the incoming command of the initiator (e.g., which may use data provided in the incoming command to update an expected state of a next frame of the initiator). Here, the incoming frame may be validated using a SAS, a SATA, and/or a fibre channel protocol. The initiator of the incoming frame may be validated through a SCSI protocol. The conversion module 502 may process a header data of the incoming command in one or more queue structures and a payload data of the incoming command in one or more payload buffers, as illustrated in FIG. 4.

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media. The software 624 may further be transmitted and/or received over a network 626 via the network interface device 620.

While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium”shall accordingly be taken to include, but not be limited to, solid-state memories, optical and magnetic media, and carrier wave signals.

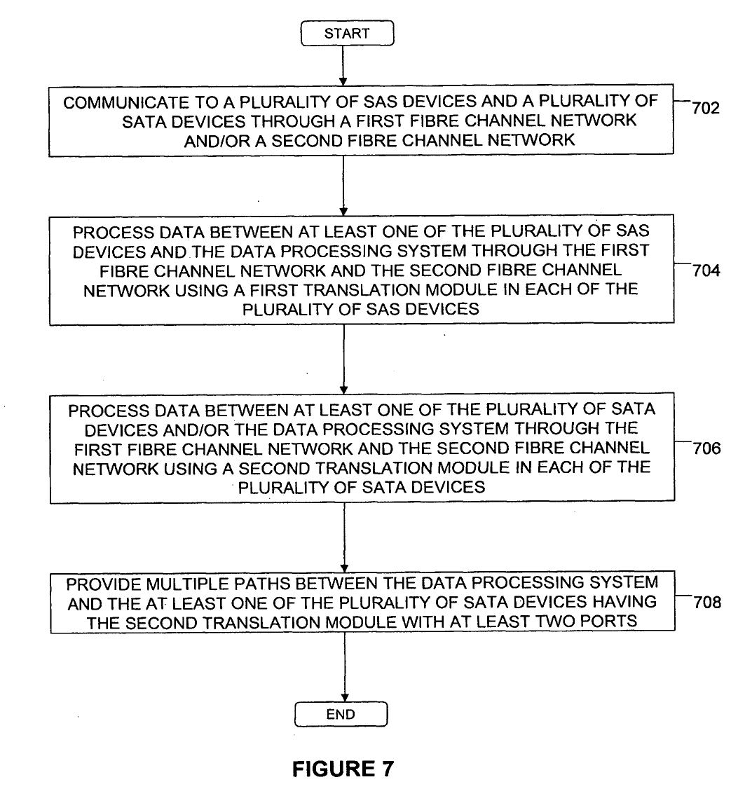

FIG. 7 is a process flow of communication between the data processing system 308 of FIG. 3 and one or more SATA/SAS devices (e.g., such as one in FIG. 5) through two fibre channel networks (e.g., as in FIG. 3), according to one embodiment. In operation 702, the data processing system 308 of FIG. 3 communicates to a plurality of SAS devices and a plurality of SATA devices through a first fibre channel network and a second fibre channel network. Then in operation 704, data is processed between one or more of the plurality of SAS devices and the data processing system 308 through the first fibre channel network and the second fibre channel network using a first translation module (e.g., of FIG. 2) in each of the plurality of SAS devices.

In operation 706, the data may be processed between one or more of the plurality of SATA devices and the data processing system 308 through the first fibre channel network and the second fibre channel network using a second translation module (e.g., of FIG. 1) in each of the plurality of SATA devices. In operation 708, at least two ports of the second translation module may provide multiple paths between the data processing system and the one or more of the plurality of SATA devices.

Although the present embodiments have been described with reference to specific example embodiments, it will be evident that various modifications and changes may be made to these embodiments without departing from the broader spirit and scope of the invention. For example, the various modules, devices, contexts, queues, buffers, networks, etc. described herein may be performed and created using hardware circuitry (e.g., CMOS based logic circuitry), firmware, software and/or any combination of hardware, firmware, and/or software.

For example, the module 100/200/502, the logic 418, the payload buffers 400/402, the queues 406-414, the conversion module 502, the controller module 504, the mapping module 506, the active-active module 508, the context 510, etc. may be embodied using transistors, logic gates, and electrical circuits (e.g., application specific integrated ASIC circuitry) using a module circuit, a logic circuit, a payload buffer circuit, a queue circuit, a conversion circuit, a controller circuit, a mapping circuit, an active-active circuit, a context circuit, etc. In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A system, comprising:
a data processing system to communicate a fibre channel frame through a network; and
a conversion module in a storage device coupled to the network to translate between the fibre channel frame and at least one of a SATA frame and a SAS frame.

2. The system of claim 1 wherein a controller module coupled to the conversion module to process the SATA frame and the SAS frame.

3. The system of claim 1 further comprising an active-active module of the conversion module to provide multiple paths from the data processing system to the storage device.

4. The system of claim 3 wherein the active-active module to enable processing of 128 concurrent commands from at least 32 data processing systems through a processor having separate payload buffers for data throughput from queue structures for processing header information.

5. The system of claim 1 wherein the conversion module to process the fibre channel frame and other fibre channel frames on a frame by frame basis.

6. The system of claim 5 wherein a context of the conversion module is associated with at least one outstanding command.

7. The system of claim 6 wherein the context includes information comprising a MTU size, a SAS hash address, a fibre channel source identifier, an expected state, a pointer allocation for putting on queue, and a command descriptor block (CDB).

8. The system of claim 7 wherein the context is of a fixed size and wherein the context is allocated prior to receiving the fibre channel frame and the other fibre channel frames.

9. The system or claim 1 wherein an expected frame state is maintained to anticipate and expedite at least one of an expected fibre channel frame, an expected SATA frame, and an expected SAS frame processed by the conversion module.

10. The system of claim 9 wherein the expected frame state is created prior to forwarding the at least one of the expected fibre channel frame, the expected SATA frame, and the expected SAS frame.

11. The system of claim 10 wherein an expected frame validation includes performing a protocol validation through at least one header validation operation.

12. The system of claim 1 further comprising a mapping module of the conversion module to translate between
a logical block address and a logical block address count for at least one of a 520 block, a 524 block, and a 528 block hard disk SCSI command and
a corresponding logical block address and a corresponding logical block address count for a 512 block SATA disk.

13. The system of claim 12 wherein the mapping module to flow through the translation while at least one of a next fibre channel frame, a next SATA frame, and a next SAS frame is processed by the conversion module.

14. An apparatus comprising:
a conversion module in a storage device to convert an incoming command of an initiator to a format of a communication protocol associated with the storage device; and
a controller module of the storage device coupled to the conversion module to generate an output data responsive to the incoming command.

15. The apparatus of claim 14, wherein the initiator is a data processing system and the storage device is at least one of a SATA and a SAS device.

16. The apparatus of claim 14 wherein the initiator to use data provided in the incoming command to update an expected state of a next frame of the initiator.

17. The apparatus of claim 14 wherein at least one of a SAS, a SATA, and a fibre channel protocol to validate an incoming frame, and a SCSI protocol to validate the initiator of the incoming frame.

18. The apparatus of claim 14 wherein the apparatus to process a header data of the incoming command in at least one queue structure and a payload data of the incoming command in at least one payload buffer.

19. A method, comprising:
a data processing system communicating to a plurality of SAS devices and a plurality of SATA devices through a first fibre channel network and a second fibre channel network;
processing data between at least one of the plurality of SAS devices and the data processing system through the first fibre channel network and the second fibre channel network using a first translation module in each of the plurality of SAS devices; and
processing data between at least one of the plurality of SATA devices and the data processing system through the first fibre channel network and the second fibre channel network using a second translation module in each of the plurality of SATA devices.

20. The method of claim 19 further comprising providing multiple paths between the data processing system and the at least one of the plurality of SATA devices using at least two ports of the second translation module.
